(19) United States
(12) Patent Application Publication
(10) Pub. No.: US 2025/0239018 A1
(43) Pub. Date: Jul. 24, 2025

(54) System and Method for 3D Scene Reconstruction

(71) Applicants: Travis Carona, Cedar Park, TX (US); Kate Ritter, Austin, TX (US)

(72) Inventors: Travis Carona, Cedar Park, TX (US); Kate Ritter, Austin, TX (US)

(73) Assignee: HomeHynd Holdings Inc., Austin, TX (US)

(21) Appl. No.: 19/030,789

(22) Filed: Jan. 17, 2025

Related U.S. Application Data
(60) Provisional application No. 63/623,168, filed on Jan. 19, 2024.

(51) Int. Cl. G06T 17/20; G06T 15/06; G06T 15/20; G06V 10/26

(52) U.S. Cl. CPC G06T 17/20; G06T 15/06; G06T 15/20; G06V 10/26; G06T 2210/04; G06T 2210/21

(57) ABSTRACT

A system and method is provided for reconstructing a 3D scene from a single 2D image. In one embodiment, AI techniques and computer vision is used to isolate structural elements from non-structural ones. Semantic object removal precedes a process that translates 2D image coordinates into a 3D modeling-compatible coordinate system. A floor mask is generated, followed by a point filtering process that optimizes data for structured mesh generation. A virtual camera and ray-casting techniques infer spatial depth, enabling the creation of a fully enclosed 3D scene with architectural elements such as walls and windows. The 3D scene can then be populated, or staged, to include virtual non-structural elements (e.g., couches, tables, etc.).

### BACKGROUND OF THE INVENTION

### 1. Field of the Invention

The present invention relates to three-dimensional (3D) image reconstruction, or more particularly, to a system and method for efficiently reconstructing a 3D scene from a single two-dimensional (2D) image.

### 2. Description of Related Art

In real estate marketing, photographs of a home are commonly viewed online and provide a first impression for a potential buyer. However, many pictures of vacant homes look very similar with neutral walls and sometimes unidentified rooms. Thus, motivated sellers want the pictures of the properties they are selling to be instantly recognizable by buyers online and to appear as though the house is currently occupied, preferably with a warm and inviting appearance.

Traditionally, properties for sale have been physically staged by actually decorating the home with furnishings and other home décor to improve the perceptions and impressions of potential buyers when they view the home. However, the staging process is often expensive, time-consuming and labor intensive. As such, there is a movement to generate 3D scenes (e.g., of individual rooms, etc.) and stage them virtually (e.g., with furniture, etc.) for access online.

This is conventionally done either manually, which is extremely time consuming and expensive, or through software that requires multiple images to deduce or infer a depth (z-axis) from images that are otherwise two-dimensional, having only x and y axes. However, there are times when only a single image is available, and therefore a need for software or artificial intelligence (AI) that overcomes the foregoing disadvantages and can be used to efficiently reconstruct a 3D scene from a single 2D image. The invention disclosed herein integrates current methodologies (e.g., monocular depth estimation, object detection, etc.) while introducing novel machine learning models for 3D scene reconstruction to overcome the foregoing disadvantages.

### SUMMARY OF THE INVENTION

The present invention provides a system and method for reconstructing a 3D scene from a single 2D image, which can be used for virtual staging in real estate and eliminates the need for multiple images, stereo vision, or known distances typically required for 3D scene generation. The same system can also be used in the sale and/or advertising of furniture (or the like), allowing the user to see an item in use (e.g., a couch in a living room, etc.).

In a preferred embodiment, the present invention employs AI techniques and computer vision to isolate structural elements from non-structural ones. Semantic object removal precedes a process that translates 2D image coordinates into a 3D modeling-compatible coordinate system. Using tools such as the LAMA algorithm, a floor mask is generated, followed by a point filtering process that optimizes data for structured mesh generation. A virtual camera and ray-casting techniques infer spatial depth, enabling the creation of a fully enclosed 3D scene with architectural elements such as walls and windows.

Of particular importance, semantic segmentation is used to create masks for different semantic elements (e.g., floors and other ground surfaces, windows, doors, glass, walls, and structural elements). In one embodiment, a LAMA algorithm is used to create a black and white mask from the image, highlighting specific elements such the floor, windows, etc. A virtual camera is then positioned within a 3D scene. The image (or a mask thereof) is then used as a reference for deducing 3D coordinates through a ray casting technique.

Specifically, the system will create a camera object positioned at the center of the x-axis but set back from the image (or mask thereof). The system uses a point in the z-axis, just behind the viewable image to simulate an actual camera position, and an elevation in the y-axis simulating the height of the camera. The original reference floor plane serves as the ground plane to judge ray intersection to determine the 3rd point in a 3D pointset. A ray-cast operation is then performed, which is to say a value is stored for an intersection point by finding the intersection of the origin of the ray from the camera, in the deduced direction it's traveling, and at which point it hits the floor plane. This process is preferably repeated many times to determine z-coordinates for a plurality of points within the image, or the mask portion thereof.

A more complete understanding of a system and method for reconstructing a 3D scene from a single two-dimensional (2D) image, including additional processes for preferred and certain embodiments, will be afforded to those skilled in the art, as well as a realization of additional advantages and objects thereof, by a consideration of the following detailed description. Reference will be made to the appended sheets of drawings, which will first be described briefly.

### BRIEF DESCRIPTION OF THE DRAWINGS

FIG. 1 depicts translation of coordinates from a 2D image into a 3D-compatible system;

FIG. 2 illustrates the concept of ray casting for depth inference or how the system derives a 3rd point in a 3D plane using a camera and a floor plane for reference against the client's submitted canvas or image;

FIG. 3 illustrates the generation of a floor mesh, preferably derived from a 3D room mask (see FIG. 7);

FIG. 4 depicts how an enclosed scene can be inferred by connecting all open lines of the scene behind the camera's location;

FIGS. 5 and 6 illustrate how other structures (e.g., walls, windows, etc.) can either be added (or extended from) the floor mesh (see FIG. 3) or derived from the 3D room mask (see FIG. 7);

FIG. 7 illustrates a 3D room mask, which can be derived using computer vision software;

FIG. 8 depicts certain system components that may be used in the present invention, including a web server, at least one application, and at least one database or memory device;

FIGS. 9 and 10 depict an exemplary 3D room mask (FIG. 10) derived from an exemplary 2D image (FIG. 9);

FIG. 11 exemplifies how ray casting can be used to derive z-coordinates for different x,y-coordinates on the floor mask (see FIG. 10);

FIG. 12 exemplifies how ray casting can be used to derive z-coordinates for different x,y-coordinates on the window mask (see FIG. 10); and

FIG. 13 illustrates a method in accordance with one embodiment of the present invention.

### DETAILED DESCRIPTION OF THE PREFERRED EMBODIMENT

The present invention addresses the challenge of constructing an accurate 3D scene from a single 2D image, utilizing artificial intelligence (AI) and advanced computational techniques. It revolutionizes virtual staging in real estate by eliminating the need for multiple images, stereo vision, or known distances typically required for 3D scene generation. The present invention allows anyone to create a 3D mesh of a room, yard or office space from a single image, followed by setting 3D models within the newly constructed scene (e.g., staging) in order to render realistic images. The invention introduces a method that simplifies the process while maintaining high accuracy and realism.

The present invention employs AI techniques and computer vision to isolate structural elements from non-structural ones. Semantic object removal precedes a process that translates 2D image coordinates into a 3D modeling-compatible coordinate system. Using tools such as the LAMA algorithm, a floor mask is generated, followed by a point filtering process that optimizes data for structured mesh generation. A virtual camera and ray-casting techniques infer spatial depth, enabling the creation of a fully enclosed 3D scene with architectural elements such as walls and windows. These and additional steps and/or processes will now be discussed in greater detail, starting with the translation of coordinates from a 2D image to a 3D canvas.

It should be appreciated that while the steps and/or processes discussed herein pertain to reconstructing a 3D room from a single 2D image, the present invention is not so limited. For example, the 3D reconstruction can be for any space, including rooms (e.g., bedroom, living room, kitchen, garage, office, meeting rooms, etc.) and outdoor settings (e.g., yards, playgrounds, etc.). In other words, the present invention can be used to reconstruct a 3D scene from any single 2D image, regardless of the structure and/or space depicted therein. As such, the present invention is also not limited to real estate services and is equally applicable to other applications, such as event design, office space logistics, street view mapping, and image search. Similarly, as the 3D scene can then be staged (e.g., with virtual non-structural elements, like a couch, coffee table, etc.), the present invention can also be used in the sale and/or advertising of non-structural items, such as furniture (e.g., to allow a user to see what a couch would look like in their own living room before purchasing the item, etc.).

Translating Coordinates from Image to Canvas

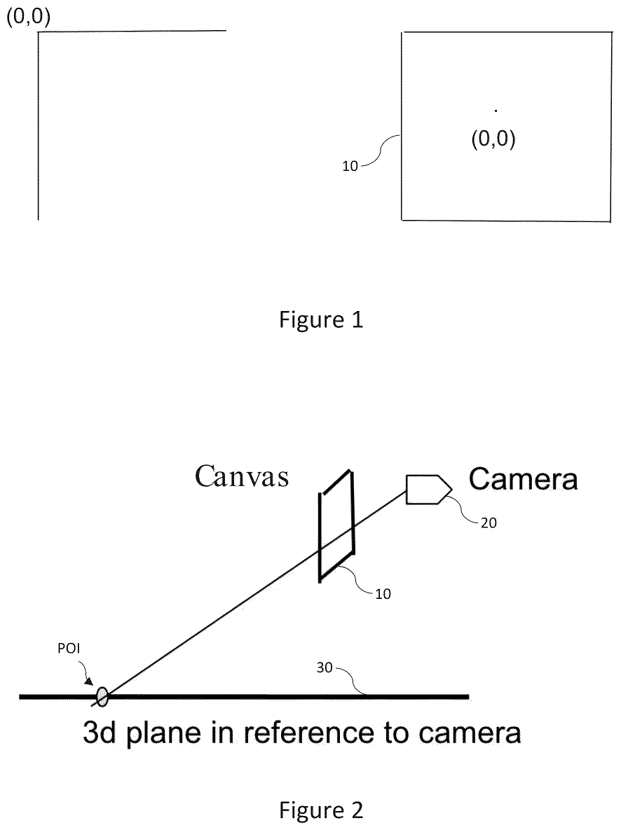

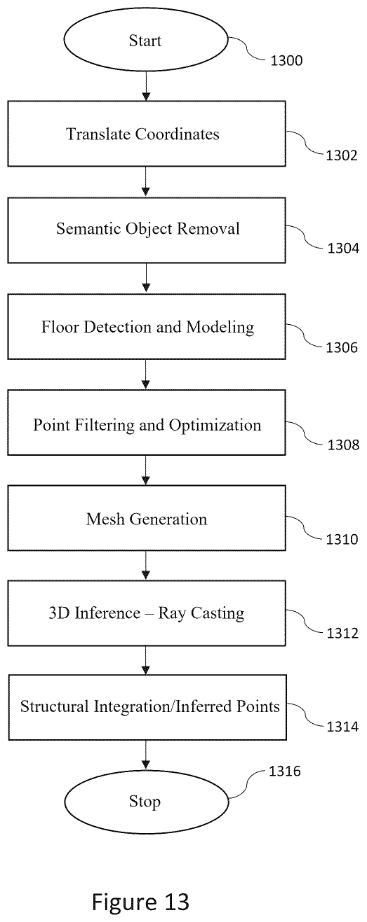

As shown in FIG. 13, the process starts by translating coordinates from a 2D image to a 3D canvas (step 1302). In one embodiment, as shown in FIG. 1, the top left corner of the image is presumed to have coordinates 0,0 (0 on the x-axis and 0 on the y-axis). However, in other embodiments, the system could assign a different location for coordinates 0,0 (e.g., the lower right corner, etc.). In either embodiment, these coordinates are translated to a 3D canvas (10). In one embodiment, this translation results in coordinates 0,0 being roughly in the center of the 3D canvas, with the 2D image also centered (roughly) on the 3D canvas.

The purpose of the translation is so that the coordinates can be used by 3D modeling software, such as Blender, Maya, or Houdini. While this step is important in deriving the third dimension (z-axis) (see discussion below), it should be appreciated that because the translation is modeling software dependent, other translation techniques, including those where coordinates 0,0 and/or the image is not centered on the canvas, are within the spirit and scope of the present invention.

As a 2D image uses a Cartesian coordinate system with two perpendicular axes, with “x” being the horizontal axis and “y” being the vertical, deducing a z-axis coordinate (depth) to imply a third dimension exists in the 2D image can be done in various ways. However, in the present invention, instead of deducing a point using the geometric displacement of a point between two photographs, starts by translating the origin of the 0,0 x,y axes, to a 3D modeling canvas (10) and places the known point of 0,0 onto the 0,0,0 origin of the 3D modeling canvas (10). With the known origin in three dimensions, a floor plane can be created on all sides of the new third dimension, creating a large reference plane for ray-casting (see discussion below).

This plane, serving as a reference surface, can then be used as an intersection target when calculating a 3D point where a ray intersects the floor plane. This will provide a guaranteed intersection point regardless of the image size and ensures consistent depth calculations during point generation.

The floor plane will also act in the end result as visual feedback. By adding a shadow casting property, the system is able to act in a more realistic manner when displaying 3D models against the constructed scene. The floor plane can also be used to optimize field of view and maintain right angles in the scene.

### Semantic Object Removal

As shown in FIG. 13 at step 1304, prior to scene reconstruction, the method employs a semantic object removal process, identifying and removing non-structural elements for a more accurate 3D reconstruction. Since the mesh construction starts with knowing the boundaries of the floor plane of the room or area, the system needs to remove all superfluous objects from the scene and detect the boundaries of the scene. The semantic object removal can be done with any library such that it identifies the objects in the space and removes them from the 2D scene. Such objects may include, for example, couches, coffee tables, exercise equipment, or other non-structural elements that are within the image. The result is an image of structure elements (e.g., floor, walls, windows, etc.), which will let the system determine the full edges and boundaries of structural elements in the scene.

### Floor Detection and Modeling

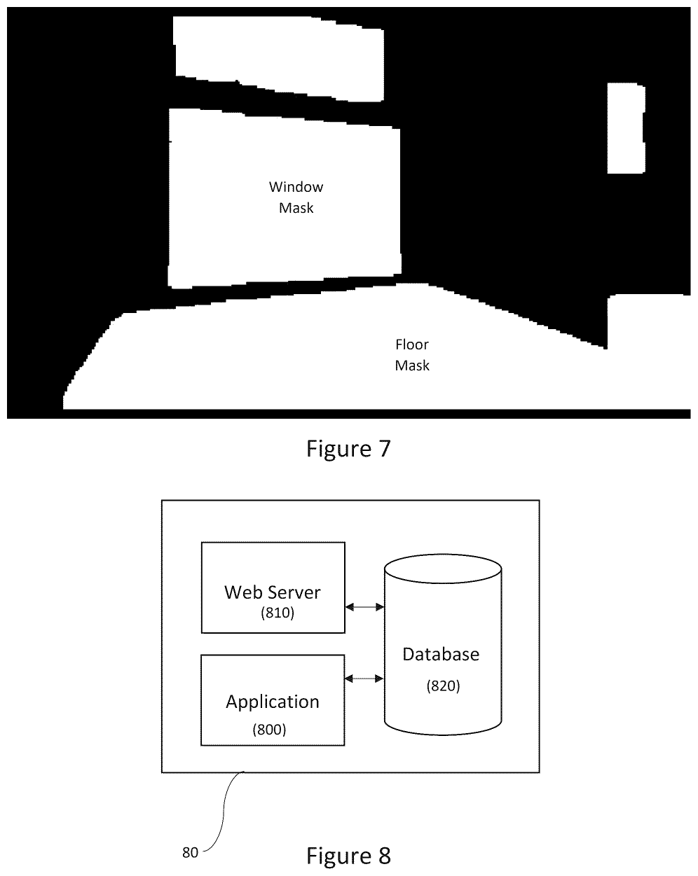

With non-structural elements removed, in certain instances replaced with structural elements (e.g., extending the floor and/or wall to where the couch once was, etc.), the system uses semantic segmentation on the image to create masks for the different semantic elements (e.g., floors and other ground surfaces, windows, doors, glass, walls, and structural elements). See FIG. 13, step 1306. This can be seen, for example, in FIG. 7, where a LAMA algorithm is used to create a black and white mask from the image, highlighting specific elements such the floor, windows, etc.

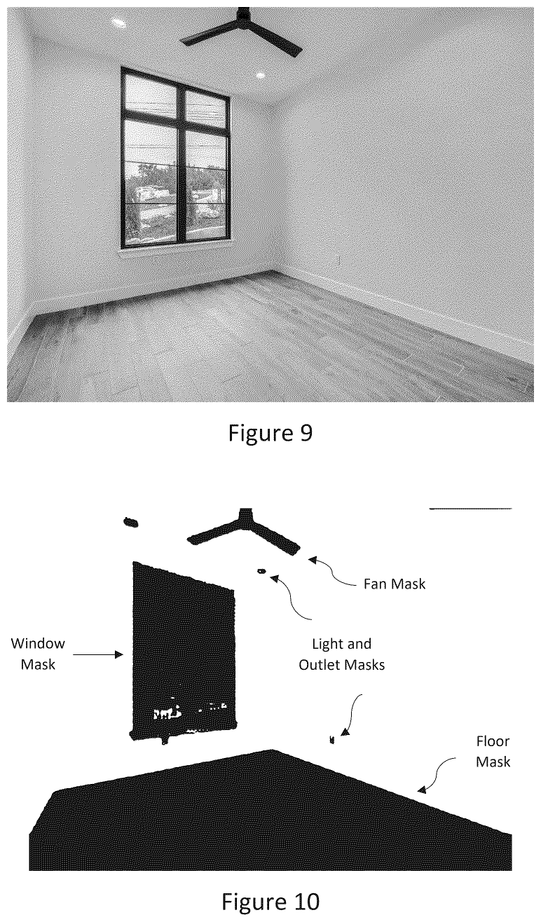

This can better be seen in FIGS. 9 and 10, where FIG. 9 is a 2D image of a room having a floor, walls, a window, an outlet, light fixtures, and a fan. Using semantic segmentation (e.g., using a LAMA algorithm or other advanced computer vision techniques), these structures can be presented via a black and white mask (see FIG. 10), which highlights specific structures (e.g., floor, window, fan, lights, outlet).

While computer vision techniques can be used to identify or differentiate between different structures, they will most likely create very jagged edges that will require a method of anti-aliasing to smooth out the edges to build the scene. This requires that the structures (e.g., the initial floor segment) be converted to either the color 0 or 255 against an inverted background. The result either being a purely white segment against a black background, or a purely black segment against a white background. The system may now sample multiple pixels located next to each other, calculate the average color value, and where the system returns either closer to white, return white, or if it returns closer to black, return black.

In one embodiment, the system defines a kernel for morphological operations, a structuring element, to find contours. It will iterate through each contour and calculate the area, if the area is less than a 10×10 pixel threshold, which is deemed to be spurious jagged edge, the system removes the contour. This will help provide straighter edges like one would encounter in a normal room or enclosed environment, helping ensure that corners and the attachment of wall segments are at the appropriate angle.

### Point Filtering and Optimization

As shown in FIG. 13 at step 1308, after generating initial line points from the floor mask, a meticulous point filtering and optimization process is applied, ensuring the accurate representation of the scene.

In one embodiment, the system begins by ingesting the newly generated floor mask and converting it into an array of x,y coordinates that represent the floor boundary edges, room corner location, wall-floor intersections, and potential doorway openings. These coordinates should first be filtered and sorted with noise reduction, as mentioned in the previous step with anti-aliasing, then passed through geometric ordering. The initial sort for this is by x-coordinates, giving the system geometric ordering of the floor from left to right in the scene as seen via the original images camera view.

Assuming that the points are in the correct order, the system can create edges between sequential points. If there is not another sequential point, that line segment is closed and another line segment begins. This accounts for protrusions in an x-coordinate space, where part of the floor extends behind another part of the visible floor space, for instance, a protruding fireplace. The filtered points are then stored in JSON format in key value pairs, with the floor being an array of filtered floor boundary points, windows, and furniture label locations.

### Mesh Generation

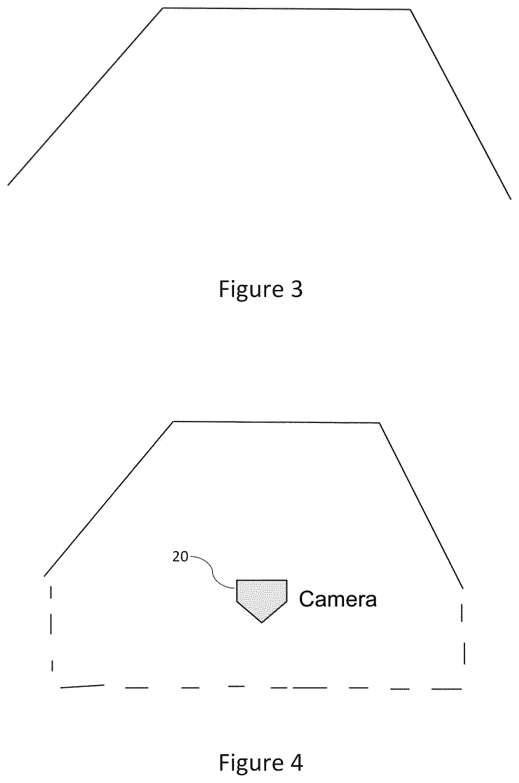

After point filtering and optimization, mesh generation is then performed at step 1310. See FIG. 13. This can be seen, for example, in FIG. 3, where the filtered points are used to generate a mesh that represents the floor of the 3D scene. This mesh is a structured representation of the ground plane, capturing the spatial layout of the scene. In other words, after the points are filtered, the system can now generate the floor geometry and, in certain embodiments, create wall extrusions, place windows and doors, and define other room boundaries.

The system will read in the sets of data in the previous step and convert all stored points and segments into 3D vectors. For the starting point in the closest to zero “x” direction moving to the direction of infinity, the system will append points together and draw vector lines from each point to the next point. Each get appended to the next, creating a floor geometry to use in the mesh creation (the same is true for the walls, windows, etc.). The result is a structured representation of the ground plan, capturing the spatial layout of the scene that can then be used in conjunction with a camera to deduce the third dimensional point in the scene.

### Camera Positioning and 3D Inference

The next step (FIG. 13 at 1312) is camera positioning and 3D inference. In the 3D reconstruction phase, a virtual camera is positioned within a 3D scene. The 2D image (on the canvas) is used as a reference for deducing 3D coordinates through a ray casting technique. Specifically, as shown in FIG. 2, the system will create a camera object 20 positioned at the center of the x-axis but set back from the canvas 10. The system will use a point in the z-axis, just behind the viewable image to simulate an actual camera position, and an elevation in the y-axis simulating the height of the camera 20. In one embodiment, the camera 20 is given a 60-degree field of view by default with a clip of 0.1 and 100 in line with a normal lens FOV. These parameters, which are not limitations of the present invention, but are merely preferences, may be either manually or programmatically determined depending on the use case.

The original reference floor plane 30 will now serve as the ground plane to judge ray intersection to determine the 3rd point in a 3D pointset. While not a limitation of the present invention, the inventors have realized that there are certain advantages to the canvas 10 being perpendicular to the floor plane 30. In a preferred embodiment, each coordinate is converted into nomalized device coordinates (NDC), which allow for device independent positioning. The system grabs the scene width and height from the original image and converts the x and y coordinates:

ndc_x=math.tan(fov/2)*(point[0]/scene_width*2−1)*scene_width/scene_height

ndc_y=math.tan(fov/2)*(point[1]/scene_height*−2+1)

Given position within the device, the coordinates are also converted and stored as view coordinates that are coordinates in relation to the viewer, which in this case is the camera object 20.

y_coordinate=math.tan(math.a tan(ndc_y)−(math.radians(90)−camera.rotation_euler[0]))+1

view_coordinates=Vector((ndc_x,−4,y))

Given the newly transformed point coordinates, the system can calculate the ray direction from the camera position by normalizing the result of subtracting the camera location from each set of view coordinates. A ray-cast operation is then performed, which is to say a value is stored for an intersection point by finding the intersection of the origin of the ray from the camera 20, in the deduced direction it's traveling, and at which point it hits the floor plane 30. This process is preferably repeated many times to determine z-coordinates for a plurality of points within the image, or the mask portion thereof.

### Inferred Points and Scene Closure

In certain embodiments, to enhance scene closure and completeness, inferred points behind the camera are introduced, contributing to closing the room in the 3D environment. This can be seen for example in FIG. 4.

### Wall Elevation and Window Integration

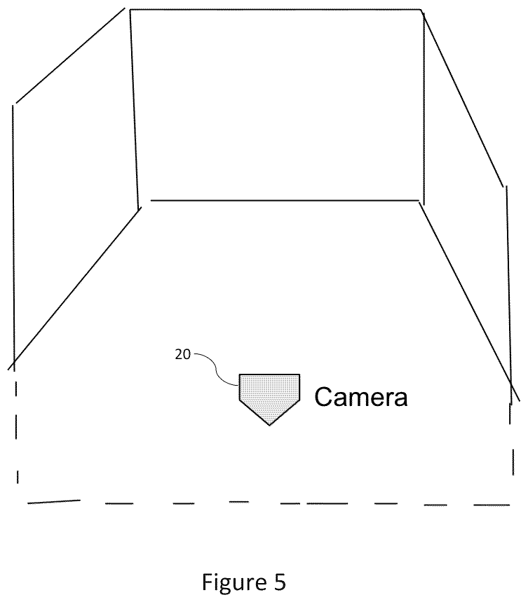

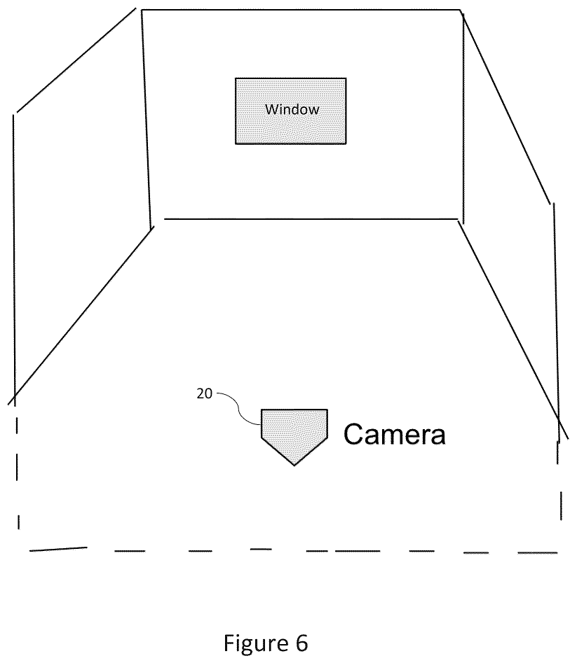

In one embodiment, following the establishment of the floor and inferred points, other structural elements are introduced. This may be accomplished using techniques similar to those described above in step 1310 (see FIG. 13) or using other methodologies. For example, as shown in FIG. 5, walls may be raised from the floor (e.g., approximately 12 feet above the floor plane). Window locations can then be integrated into the walls, adding further detail to the 3D environment.

### System Overview

The foregoing process is preferably performed on a computer, preferably with Internet access for remote use. By way of example, as shown in FIG. 8, the computer 80 will include a web server 810 for remote access, at least one application 800 configured to run at least one program, and at least one database 820 for storing various content (e.g., programs, code, 3D visualization software, 3D objects (e.g., couches, coffee tables, etc.) for virtually staging the 3D scene, etc.). It should be appreciated that the present invention is not limited to the computer 80 shown in FIG. 8 and other computers having different, fewer, and/or additional components are within the spirit and scope of the present invention.

In a preferred embodiment, at least one application program is operated to produce a set of 3D coordinates that can be used to plot the three-dimensional floor points into the 3D modeling system. While the code described herein may vary depending on use, the process preferably includes (1) initial setup, (2) camera configuration, (3) 3D point generation, (4) mesh generation process, (5) adaptive camera adjustments, and (6) Intelligent point selection. Certain details concerning this process, which are not limitations of the present invention, but merely preferences, are as follows:
1. (a) sets up a logging system that will write all operations to a file called “create_mesh.log,” (b) each log entry will include a timestamp and message, and (c) creates an empty “room” object in Blender that will act as a parent container for all the 3D elements we create (walls, floors, windows).
2. (a) position the camera 5 units back and 1 unit up from the center, (b) sets the camera to use Euler rotation (XYZ angles), (c) points the camera straight down (90 degrees), and (d) sets the camera's field of view to 60 degrees (creates a consistent viewing angle for converting 2D points to 3D).
3. (a) takes a 2D point from the image and converts it to 3D space, (b) uses the camera's field of view to calculate how the 2D coordinates map to 3D, (c) converts screen coordinates to normalized device coordinates (NDC), and (d) uses ray casting to find where the point would intersect with the floor plane (converting flat image points into 3D space points).
4. (a) takes the 3D points calculated and creates actual 3D geometry, (b) for walls: create vertical surfaces by connecting floor points to ceiling points, (c) for windows: creates rectangular openings in the walls, and (d) creates the actual 3D mesh by defining vertices (points), edges (lines) and faces (surfaces).
5. (a) fine-tunes the camera's field of view to ensure accurate angles in the 3D model, (b) works by iteratively adjusting the camera until the angles between points match the expected values (crucial for maintaining proper proportions in the final 3D model), and (c) stops adjusting when the angles are within 1 degree of the target.
6. (a) analyzes the points to find the best ones for camera calibration, (b) looks for points that for approximately right angles (90 degrees), (c) consider the distance between the points to find major structural corners, (d) these selected points are used to ensure the 3D model maintains proper proportions and angles, and (e) particularly focuses on points that are likely to be room corners or major structural elements.

Clearly, variations of the foregoing are within the spirit and scope of the present invention. For example, depending on the application and/or configuration, the method may include additional, fewer, or different steps, or steps performed in a different order. For example, the “inferred points and scene closure” step (1314) may be omitted or performed before the “camera positioning and 3D inference” step (1312). Similarly, it should be appreciated that the code itself for each step may vary depending on the application, configuration, and/or 3D modeling software that is being used. For example, any method of positioning a camera with respect to the 3D canvas and detecting a point of intersection (POI) with a 3D plane, is within the spirit and scope of the present invention, as the whole purpose of the ray casting technique is to identify a z-coordinate for each x,y-coordinate on the mask.

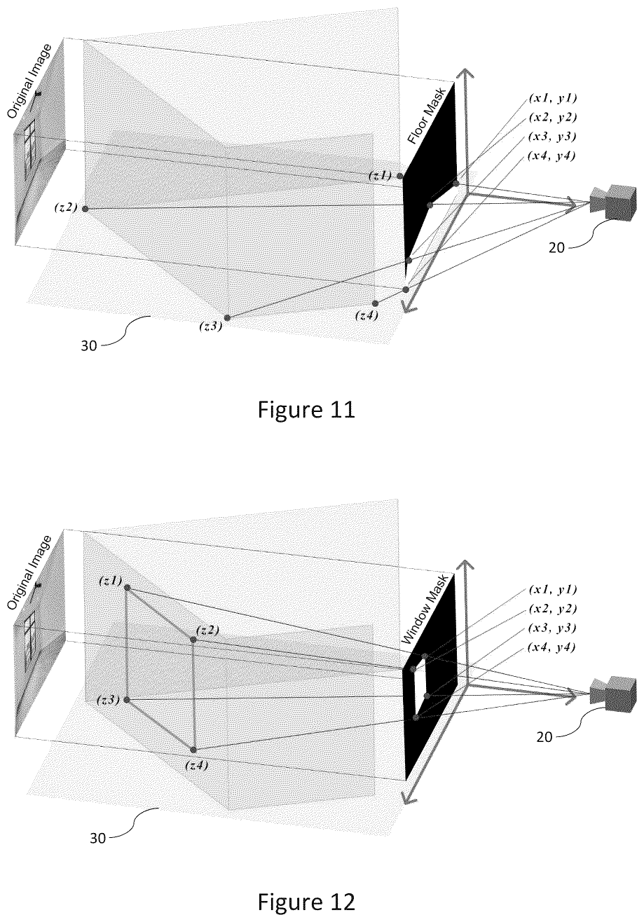

This can be seen in FIG. 11, where different rays from the camera 20 are used to identify different z-coordinates for different areas on the floor mask. For example, a ray passing through x1,y1 of the mask, will intersect the floor plane 30 at z1, a ray passing through x2,y2 of the mask, will intersect the floor plane 30 at z2, and so forth. The same technique can be used to identify z-coordinates for the window (see FIG. 12), each wall, etc. In other words, the ray casting technique can be used to identify z-coordinates for any structural item identified in step 1306. As shown in FIGS. 11 and 12, these coordinates can then be used to create a 3D mesh for the room. In one embodiment, the original image can then be superimposed (e.g., behind the mesh) to provide a realistic impression of the room after 3D reconstruction.

Advantages of the present invention include efficient single-image 3D scene reconstruction, where the method's efficiency lies in its ability to reconstruct detailed 3D scenes from a single 2D image, eliminating the need for a multitude of photos typically required by traditional methods. Unlike traditional methods, the present invention includes efficient “z” coordinate estimation, procedurally generated mesh for detailed scene recreation, and a sophisticated point optimization process that streamlines the reconstruction process.

This invention not only solves existing challenges in single image to 3D scene reconstruction but also presents extensive commercial opportunities across various industries. Upon successful implementation, the present invention will significantly enhance efficiency and user experience, particularly in virtual design and 3D rendering applications, as it marks a paradigm shift in cutting-edge software, unlocking numerous possibilities for product applications.

The foregoing description of a system and method for 3D image reconstruction has been presented for the purposes of illustration and description. It is not intended to be exhaustive or to limit the invention to the precise forms disclosed, and many modifications and variations are possible in light of the above teachings. Those skilled in the art will appreciate that there are a number of ways to implement the foregoing features, and that the present invention it not limited to any particular way of implementing these features. The invention is solely defined by the following claims.

What is claimed is:

1. A method for reconstructing a three-dimensional (3D) scene from a single two-dimensional (2D) image, said 2D image depicting a room having a floor portion and at least one wall portion, comprising:
generating a floor mask for said floor portion of said room, wherein said floor mask identifies at least an outline of said floor portion depicted in said 2D image;
positioning said floor mask in a 3D space with known x and y-coordinates;
positioning a virtual camera in said 3D space at predetermined coordinates with respect to said floor mask, said predetermined coordinates including at least an x-coordinate, a y-coordinate, and a z-coordinate;
using a ray casting technique to identify a line that travels from said virtual camera and through a first x and y-coordinates of said floor mask;
identifying a point of intersection (POI) of said line with a 3D plane in said 3D space below said floor mask, said POI being a first z-coordinate for said first x and y-coordinates; and
using at least said first x and y-coordinates and said first z-coordinate to generate a 3D scene of said room depicted in said 2D image.

2. The method of claim 1, wherein said step of using at least said first x and y-coordinates and said first z-coordinate to generate a 3D scene of said room further comprises further using said predetermined coordinates of said virtual camera to generate said 3D scene of said room depicted in said 2D image.

3. The method of claim 1, further comprising the steps of identifying a plurality of lines that travel from said virtual camera and through a plurality of x and y-coordinates of said floor mask and identifying a plurality of corresponding POIs, wherein said plurality of POIs are used, along with said first x and y-coordinates and said first z-coordinate, to generate said 3D scene of said room depicted in said 2D image.

4. The method of claim 3, wherein said step of using said first x and y-coordinates, said first z-coordinate, and said plurality of POIs to generate said 3D scene of said room further comprises further using said predetermined coordinates of said virtual camera to generate said 3D scene of said room depicted in said 2D image.

5. The method of claim 1, further comprising the step of semantic object removal from said 2D image prior to said step of generating a floor mask for at least said floor portion of said room.

6. The method of claim 1, further comprising the step of point filtering and optimizing said floor mask prior to using said ray casting technique to identify said line that travels from said virtual camera and through said first x and y-coordinates of said floor mask.

7. The method of claim 1, further comprising the steps of generating a wall mask for said wall portion of said room, wherein said wall mask identifies at least an outline of said wall portion depicted in said 2D image, and using said ray casting technique to identify at least one z-coordinate associated with said wall mask portion to generate said 3D scene of said room depicted in said 2D image.

8. The method of claim 1, further comprising the step of translating coordinates from said 2D image to a 3D canvas that includes said floor mesh.

9. A system for reconstructing a three-dimensional (3D) scene from a single two-dimensional (2D) image, said 2D image depicting a room having a floor portion and at least one wall portion, comprising:
at least one computing device in communication with at least one wide area network (WAN) and comprising at least one memory device for storing machine readable instructions adapted to perform the steps of:
generating a floor mask for said floor portion of said room, wherein said floor mask identifies at least an outline of said floor portion depicted in said 2D image;
positioning said floor mask in a 3D space at known x and y-coordinates;
positioning a virtual camera in said 3D space at predetermined coordinates with respect to said floor mask, said predetermined coordinates including at least an x-coordinate, a y-coordinate, and a z-coordinate;
using a ray casting technique to identify a line that travels from said virtual camera and through a first x and y-coordinates of said floor mask;
identifying a point of intersection (POI) of said line with a 3D plane in said 3D space below said floor mask, said POI being a first z-coordinate for said first x and y-coordinates; and
using at least said first x and y-coordinates and said first z-coordinate to generate a 3D scene of said room depicted in said 2D image.

10. The system of claim 9, wherein said step of using at least said first x and y-coordinates and said first z-coordinate to generate a 3D scene of said room further comprises further using said predetermined coordinates of said virtual camera to generate said 3D scene of said room depicted in said 2D image.

11. The system of claim 9, wherein said machine readable instructions are further configured to identify a plurality of lines that travel from said virtual camera and through a plurality of x and y-coordinates of said floor mask and identify a plurality of corresponding POIs, wherein said plurality of POIs are used, along with said first x and y-coordinates and said first z-coordinate, to generate said 3D scene of said room depicted in said 2D image.

12. The system of claim 11, wherein said step of using said first x and y-coordinates, said first z-coordinate, and said plurality of POIs to generate said 3D scene of said room further comprises further using said predetermined coordinates of said virtual camera to generate said 3D scene of said room depicted in said 2D image.

13. The system of claim 9, wherein said machine readable instructions are further configured to perform semantic object removal from said 2D image prior to said ray casting.

14. The system of claim 9, wherein said machine readable instructions are further configured to perform point filtering and optimization on said floor mask prior to said ray casting.

15. The system of claim 9, wherein said machine readable instructions are further configured to generate a wall mask for said wall portion of said room, wherein said wall mask identifies at least an outline of said wall portion depicted in said 2D image, and use said ray casting technique to identify at least one z-coordinate associated with said wall mask portion to generate said 3D scene of said room depicted in said 2D image.

16. The system of claim 9, wherein said machine readable instruction are further configured to translate coordinates from said 2D image to a 3D canvas that includes said floor mesh prior to said ray casting.

17. A method for reconstructing a three-dimensional (3D) scene from a single two-dimensional (2D) image, said 2D image depicting a room having a floor portion and at least one wall portion, comprising:
generating at least an outline of said floor portion depicted in said 2D image, said outline being position on a canvas in a 3D space with known x and y-coordinates;
positioning a virtual camera in said 3D space at predetermined coordinates with respect to said canvas, said predetermined coordinates including at least an x-coordinate, a y-coordinate, and a z-coordinate;
using a ray casting technique to identify a line that travels from said virtual camera and through a first x and y-coordinates of said canvas;
identifying a point of intersection (POI) of said line with a 3D plane in said 3D space below said canvas, said POI being a first z-coordinate for said first x and y-coordinates; and
using at least said first x and y-coordinates and said first z-coordinate to generate a 3D scene of said room depicted in said 2D image.

18. The method of claim 17, wherein said step of using at least said first x and y-coordinates and said first z-coordinate to generate a 3D scene of said room further comprises further using said predetermined coordinates of said virtual camera to generate said 3D scene of said room depicted in said 2D image.

19. The method of claim 17, further comprising the steps of identifying a plurality of lines that travel from said virtual camera and through a plurality of x and y-coordinates of said canvas and identifying a plurality of corresponding POIs, wherein said plurality of POIs are used, along with said first x and y-coordinates and said first z-coordinate, to generate said 3D scene of said room depicted in said 2D image.

20. The method of claim 17, wherein said outline of said floor portion comprises a floor mask of said floor portion.
